(19) United States
(12) Patent Application Publication
(10) Pub. No.: US 2007/0003466 A1
(43) Pub. Date: Jan. 4, 2007

(54) Method for producing tetrafluorosilane

(76) Inventor: Masakazu Oka, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/573,038

(22) PCT Filed: Sep. 24, 2004
(86) PCT No.: PCT/JP04/14419

§ 371 Date: Mar. 22, 2006

Related U.S. Application Data
(60) Provisional application No. 60/508,876, filed on Oct. 7, 2003.

(30) Foreign Application Priority Data
Sep. 25, 2003 (JP) 2003-333061

(51) Int. Cl. C01B 33/08

(52) U.S. Cl. 423/342

(57) ABSTRACT

The invention relates to a method for producing tetrafluorosilane by decomposing hexafluorosilicic acid with sulfuric acid, which comprises: step 1 of decomposing hexafluorosilicic acid in concentrated sulfuric acid in the first reactor to give SiF₄ and HF and taking out the SiF₄; step 2 of transferring part of the concentrated sulfuric acid solution of step 1 containing HF into the second reactor to react the HF with silicon dioxide fed thereinto, thereby producing SiF₄ containing (SiF₃)₂O; and step 3 of bringing the reaction product of step 2 containing (SiF₃)₂O and SiF₄ to the first reactor to react (SiF₃)₂O contained in the reactin product with HF to convert it into SiF₄ and then taking out the SiF₄ along with SiF₄ formed in step 1. According to the invention, high-purity SiF₄ can be obtained with (SiF₃)₂O being reduced, free from HF generated as a problematic side product in conventional method.

### CROSS-REFERENCE TO RELATED APPLICATIONS

This is an application filed pursuant to 35 U.S.C. Section 111(a) with claiming the benefit of U.S. provisional application Ser. No. 60/508, 876 filed Oct. 7, 2003 under the provision of 35 U.S.C. 111(b), pursuant to 35 U.S.C. Section 119(e) (1).

### TECHNICAL FIELD

The present invention relates to a method for producing tetrafluorosilane and to use of the compound.

### BACKGROUND ART

High-purity tetrafluorosilane (SiF₄) is demanded, for example, for materials for optical fibers, semiconductors and solar cells.

As production method for SiF₄, various methods are known.

Examples of conventionally known methods include a method where hexafluorosilicate is thermally decomposed.
Na₂SiF₆→SiF₄+2NaF (1)

However, metal silicofluoride such as hexafluorosilicate contains H₂O and though in a very small amount, an oxygen-containing silicate compound (e.g., SiO₂) as impurities. Therefore, when the compound without being sufficiently pretreated is subjected to thermal decomposition, hexafluorodisiloxane ((SiF₃)₂O) is generated through reaction between the impurities and SiF₄ (see formula (3) mentioned below).

Another known method of producing SiF₄ is a method where SiF₄ is produced by reacting SiO₂ with HF in the presence of concentrated sulfuric acid (see JP-A-57-135711).
4HF+SiO₂→SiF₄+2H₂O (2)

However, this method is problematic in that, when the reaction molar ratio of SiO₂ and HF in the method approaches the theoretical molar ratio, SiF₄ produced may react with SiO₂ to give hexafluorodisiloxane (SiF₃)₂O.

Still another method of producing SiF₄ known in the art is a method where an aqueous solution of hexafluorosilicic acid (H₂SiF₆) is dehydrated and decomposed with concentrated sulfuric acid to produce SiF₄ (see JP-A-9-183608). However, this method also gives hydrogen fluoride (HF) as a by-product like in the above-mentioned thermal decomposition. In the method disclosed, the starting compound H₂SiF₆ is taken out as a side product in a process of producing phosphoric acid, and the by-product HF is brought back to the phosphoric acid production process. Accordingly, since the method indispensably requires the phosphoric acid production process as prerequisite, it is difficult to apply the method to various starting materials.

Still another method of producing SiF₄ also known in the art is a method where H₂SiF₆ is fed into a vertical column reactor and decomposed with sulfuric acid to produce SiF₄ (see JP-A-60-11217 (European Patent No. 129112). Like in the above method, this method also gives hydrogen fluoride (HF) as a by-product and is therefore problematic in that HF is recovered as being contained in sulfuric acid. A method of suspending SiO₂ in H₂SiF₆ and reacting it with HF is described in the document, but this is also problematic in that, when the amount of SiO₂ equimolar to that of HF is fed into the system, (SiF₃)₂O is generated as a side product.
3SiF₄+SiO₂→2SiF₃OSiF₃ (3)

In a case where SiF₄ contains impurity gases such as (SiF₃)₂O, CO₂ and O₂, when SiF₄ is used as a starting material for silicon thin films, the impurities may cause contamination with oxygen to adversely affect the characteristics of semiconductors and fibers. Accordingly, a demand for high-purity SiF₄ containing impurities in a smaller amount is increasing.

As a method for purifying SiF₄ that contains (SiF₃)₂O, CO₂ or HF, for example, there is known a method of treating SiF₄ containing (SiF₃)₂O with an adsorbent (see JP-A-57-156317). However, when thus used adsorbent is heated and regenerated, in some cases, its original adsorbability cannot be restored. Although the reason is unclear, it may be assumed that (SiF₃)₂O adsorbed by it is decomposed inside the pores of the adsorbent. SiO₂ produced through the decomposition clogs the pores of the adsorbent, and makes it difficult to recycle the adsorbent, causing a problem that the used adsorbent must be discarded as a waste. In addition, if the adsorbent is insufficiently baked before gas circulation, the side reaction with water may cause formation of (SiF₃)₂O.

### DISCLOSURE OF THE INVENTION

The present invention has been made in consideration of the background as above, and its objects are to provide a method for producing tetrafluorosilane from a starting material hexafluorosilicic acid, in which problematic impurities (especially hexafluorodisiloxane) generated in conventional thermal decomposition or sulfuric acid decomposition are efficiently reduced, thereby solving the problem of the side product HF to give high-purity tetrafluorosilane, and to provide use of the compound.

The present inventors have made intensive studies so as to solve the above problems, and, as a result, have found that SiF₄ can be produced in a process which comprises

step (1) of decomposing H₂SiF₆ with sulfuric acid to give SiF₄,

step (2) of reacting HF which has been dissolved in sulfuric acid in step (1) with SiO₂ to give SiF₄, and step (3) of bringing SiF₄ containing (SiF₃)₂O which has been formed in step (2) back to step (1) so that (SiF₃)₂O is reacted with HF to give SiF₄ and water, and have also found that, by further subjecting SiF₄ thus produced to a step of contacting it with concentrated sulfuric acid and with molecular sieving carbon, SiF₄ having a much higher purity can be obtained. Based on these findings, the present invention has been completed.

Specifically, the invention relates to a method for producing SiF₄ of the following [1] to [14], and to use of the compound.

[1] A method for producing tetrafluorosilane by decomposing hexafluorosilicic acid with sulfuric acid, which comprises:

a step of decomposing hexafluorosilicic acid in concentrated sulfuric acid in a first reactor to give tetrafluorosilane and hydrogen fluoride, and taking out the thus-formed tetrafluorosilane (step 1);

a step of transferring at least a part of the concentrated sulfuric acid solution of step 1 containing hydrogen fluoride into a second reactor to allow the hydrogen fluoride to react with silicon dioxide which is fed into the second reactor, thereby producing tetrafluorosilane containing hexafluorodisiloxane (step 2); and

a step of bringing the reaction product of step 2 containing hexafluorodisiloxane and tetrafluorosilane to the first reactor so that the hexafluorodisiloxane in the reaction product is reacted with hydrogen fluoride to convert it into tetrafluorosilane, and taking out the resulting tetrafluorosilane along with the tetrafluorosilane formed in step 1 (step 3).

[2] The method for producing tetrafluorosilane as described in [1], wherein an aqueous hexafluorosilicic acid solution and concentrated sulfuric acid are fed into the first reactor, silicon dioxide is fed into the second reactor each continuously or intermittently, and tetrafluorosilane is continuously or intermittently taken out of the first reactor.

[3] The method for producing tetrafluorosilane as described in [1] or [2], wherein the sulfuric acid concentrations in the first and second reactors are kept 70 mass % or more.

[4] The method for producing tetrafluorosilane as described in any one of [1] to [3], wherein the reaction temperatures in the first and second reactors are 60° C. or higher.

[5] The method for producing tetrafluorosilane as described in [1] or [2], wherein the particle size of silicon dioxide fed to the second reactor is 30 μm or less.

[6] The method for producing tetrafluorosilane as described in [1] or [2], comprising a step of contacting the tetrafluorosilane taken out of the first reactor with concentrated sulfuric acid at 50° C. or lower so that hydrogen fluoride contained in the tetrafluorosilane is absorbed and removed.

[7] The method for producing tetrafluorosilane as described in [6], wherein the tetrafluorosilane taken out of the first reactor is countercurrently contacted with concentrated sulfuric acid that is supplied through a channel to the first reactor.

[8] The method for producing tetrafluorosilane as described in [1] or [2], comprising a step of purifying the tetrafluorosilane taken out of the first reactor with molecular sieving carbon so as to remove the impurities from the tetrafluorosilane.

[9] The method for producing tetrafluorosilane as described in [8], wherein the removed impurities include one or more members selected from the group consisting of hydrogen fluoride, hydrogen chloride, sulfur dioxide, hydrogen sulfide and carbon dioxide.

[10] The method for producing tetrafluorosilane as described in [8] or [9], wherein the molecular sieving carbon to be used has a smaller pore size than the molecular size of tetrafluorosilane.

[11] The method for producing tetrafluorosilane as described in [10], wherein the molecular sieving carbon pretreated by baking in an inert gas atmosphere and then introducing thereinto high-purity tetrafluorosilane is used.

[12] Gas for production of optical fibers, which contains the tetrafluorosilane gas obtained according to the production method as described in any one of [1] to [11], comprising transition metal, phosphorus and boron each at concentration of 100 ppb or less.

[13] Gas for production of semiconductors, which contains the tetrafluorosilane gas obtained according to the production method as described in any one of [1] to [11], comprising transition metal, phosphorus and boron each at concentration of 100 ppb or less.

[14] Gas for production of solar cells, which contains the tetrafluorosilane gas obtained according to the production method as described in any one of [1] to [11], comprising transition metal, phosphorus and boron each at concentration of 100 ppb or less.

### DETAILED DESCRIPTION OF INVENTION

The invention is hereinafter described in detail.

The method for producing SiF₄ of the invention substantially comprises

step (1) of decomposing H₂SiF₆with sulfuric acid to give SiF₄ in the first reactor,

step (2) of introducing at least part of the sulfuric acid of step (1) into the second reactor to cause reaction between hydrogen fluoride dissolved in the sulfuric acid of step 1 and SiO₂ to give SiF₄, and

step (3) of bringing SiF₄ containing (SiF₃)₂O which has been formed in step (2) back to the first reactor of step (1) so that (SiF₃)₂O is reacted with hydrogen fluoride which is a by-product derived from H₂SiF₆ to give SiF₄. Specifically, as shown in FIG. 1, H₂SiF₆ is decomposed with sulfuric acid in the first reactor (step 1); at least a part of sulfuric acid containing HF as a side product is transferred into the second reactor to react with SiO₂ there into give SiF₄ containing (SiF₃)₂O as an impurity (step 2); and SiF₄ thus formed in the second reactor is brought back to the first reactor so that the impurity (SiF₃)₂O is reacted with HF present in the reactor to convert it into SiF₄ (step 3). Through the process, high-purity SiF₄ is collected, and optionally it is further subjected to purification treatment (purification step).

In the process, most of the HF formed in the step 1:
H₂SiF₆→SiF₄+2HF (4)
is consumed in the step 2:
4HF+SiO₂→SiF₄+2H₂O (2)
and in the step 3:
(SiF₃)₂O+2HF→2SiF₄+H₂O (5).

Therefore, the process is free from the problem of HF treatment. In addition, since the side product in step 2, (SiF₃)₂O is converted into SiF₄ in step 3, the process is efficient as a whole to give high-purity SiF₄.

The steps are described individually hereinbelow.

Any H₂SiF₆ produced in any method may be used without any difficulty. For example, H₂SiF₆ produced through reaction of SiO₂ with HF, and H₂SiF₆ produced through reaction of SiF₄ and HF may be used. For example, H₂SiF₆ formed as a side product in a large quantity when Si and F components contained in starting material rock phosphate are decomposed with H₂SO₄ in a process of producing phosphoric acid, which is inexpensive, may be employed in the invention.

The reaction of the step 1 is as follows:
H₂SiF₆→SiF₄+2HF (4)

In this step, sulfuric acid serves as a (dehydrating) decomposing agent. However, if the sulfuric acid concentration is low, it is unfavorable since H₂SiF₆ may stably exist in sulfuric acid and is not decomposed. Accordingly, it is preferable that the sulfuric acid concentration after mixed in the reaction system be 70 mass % or more, more preferably 75 mass % or more, most preferably 80 mass % or more. If the reaction temperature is low, it is impractical since the decomposition reaction rate becomes very low. Preferably, the decomposition is performed at 60° C. or higher so as to efficiently obtain SiF₄. However, when the reaction temperature is excessively elevated, it is unfavorable since the proportion of the decomposed side product HF and water in sulfuric acid which evaporate from the aqueous sulfuric acid solution excessively increases while the decomposition reaction may be promoted. Accordingly, the reaction temperature is preferably within a range of 60 to 120° C., more preferably 80 to 100° C.

The shape of the first reactor is not particularly limited as long as it ensures enough time for contact between concentrated sulfuric acid and H₂SiF₆ required for decomposition of H₂SiF₆. Since the decomposition reaction is extremely rapid and may finish in an instant, the contact time within a range of 0.1 to 10 seconds or so is sufficient.

By transferring HF which is formed along with the formation of SiF₄ in step 1, dissolved in sulfuric acid, to the second reactor to react with SiO₂, SiF₄ is prepared (step 2).
4HF+SiO₂→SiF₄+2H₂O (2)

SiO₂ may be solid when subjected to the reaction, but is preferably powdery in order to well disperse in the solution and efficiently undergo the reaction. The SiO₂ powder may be directly fed into the reactor, but its dispersion in sulfuric acid is preferred for continuous addition thereof. The smaller the mean particle size of SiO₂, the better the SiO₂ is dispersed. Preferably, the particle size is preferably 30 μm or less, more preferably 10 μm or less, most preferably 5 μm or less.

The concentration of SiO₂ to be dispersed in sulfuric acid may be suitably determined depending on the physical properties (e.g., particle size, density) of the powder used. However, if the concentration is too low, then the amount of sulfuric acid to be fed to the system may increase; but if too high, then the slurry may result in solid-liquid separation. Therefore, the SiO₂ concentration preferably falls within a range of 0.1 to 30 mass %. Also preferably, the purity of SiO₂ to be used herein is 90% or more, more preferably 99% or more.

The reaction temperature is preferably 60° C. or higher, more preferably falling within a range of 80 to 100° C. The amount of SiO₂ to be added to the system may be a theoretical molar amount relative to HF (¼ molar times). However, by using SiO₂ in an amount larger or smaller than the theoretical molar ratio, the concentration of HF and SiO₂ in the sulfuric acid (waste sulfuric acid) to be discharged in step 2 can be controlled. Taking the matter into consideration that the waste sulfuric acid may be used for other purposes, for example, for its reuse in decomposition of phosphate to give phosphoric acid and for its analysis for process control, it is desirable that SiO₂ is reacted with HF in such a controlled condition that HF is slightly excess over SiO₂.

When the amount of SiO₂ approximates the theoretical molar ratio relative to HF from a low molar ratio thereof, a side product (SiF₃)₂O is formed. This is assumed that SiF₄ produced reacts with SiO₂ to generate the side product.
3SiF₄+SiO₂→2SiF₃OSiF₃ (3)

When (SiF₃)₂O remains contained in SiF₄, it may adversely affect properties of semiconductors and optical fibers produced therefrom, and therefore it must be removed from SiF₄.

Accordingly, SiF₄ containing (SiF₃)₂O formed in step 2, is brought back to the first reactor, in which (SiF₃)₂O is reacted with HF in sulfuric acid in the first reactor to give SiF₄ and water, thereby removing (SiF₃)₂O (step 3).
(SiF₃)₂O+2HF→2SiF₄+H₂O (5)

The reaction condition in this step may be the same as that in step 1. The reaction of (SiF₃)₂O with HF may proceed either in a vapor phase or in a solution of sulfuric acid. When the proportion of (SiF₃)₂O produced in the process is large, it is desirable that (SiF₃)₂O is introduced into the sulfuric acid solution by bubbling so as to increase the contact time between (SiF₃)₂O and HF.

Steps 1 to 3 may be effected batch wise, but it is preferable that the steps be performed continuously. The final product SiF₄ is taken out of the vapor phase in the first reactor.

As shown in the above description and FIG. 1, SiF₄ formed in step 1, step 2 and the step 3 each contains HF and H₂O. In general, therefore, SiF₄ taken out of the first reactor is purified in a purification step.

A primary example of purification process is washing with sulfuric acid. By washing with sulfuric acid, HF and H₂O are removed from SiF₄. The method of washing with sulfuric acid may be conducted, for example, by filling a container with concentrated sulfuric acid and then introducing SiF₄ formed in steps 1 to 3 thereinto. Preferably, the method is more efficiently conducted by introducing sulfuric acid into a column from one direction while introducing SiF₄ from the opposite direction. Also more preferably, the column is charged with a filler for increasing the contact efficiency through it. The higher the sulfuric acid concentration, the more preferable to obtain a higher removal efficiency. Specifically, the sulfuric acid concentration is preferably 90 mass % or higher, more preferably 95 mass % or higher, most preferably 98 mass % or higher. In the absorption column, the sulfuric acid temperature is preferably lower to reduce evaporation of HF and water. However, if the temperature is excessively cooled, the viscosity of the liquid system in the column will increase, resulting in deterioration of handleability. Accordingly, the absorption column is driven at a temperature within a range of 10 to 50° C. Before use herein, sulfuric acid may be bubbled with N₂ so as to remove CO₂ from it. By using the thus-degassed sulfuric acid, CO₂ in SiF₄ formed in steps 1 to 3 can also be reduced through adsorption by the sulfuric acid.

After having passed through the absorption column, SiF₄ may still contain impurities such as hydrogen chloride, hydrogen sulfide, sulfur dioxide, nitrogen, oxygen, hydrogen, carbon monoxide, carbon dioxide and HF. Of the impurities, those except low-boiling-point components such as nitrogen, oxygen, hydrogen and carbon monoxide may be removed through molecular sieving carbon.

By using the molecular sieving carbon having a pore diameter smaller than the molecular diameter of SiF₄, only impurities such as HCl, H₂S, CO₂ and HF can be adsorbed without adsorbing SiF₄. Preferably, the molecular sieving carbon used herein has a pore diameter of 5 Å or less such as Molsiebon 4A (manufactured by Takeda Pharmaceutical Co., Ltd.). It is preferable that the molecular sieving carbon for use herein be previously baked at a temperature within a range of 100 to 350° C. in an inert gas such as N₂ introduced thereto, thereby removing moisture and CO₂ from it. For drying, N₂ having a dew point of −70° C. or lower is used, and when the dew point at the baking inlet becomes equal to the dew point at the outlet, the drying may be completed. After thus baked, although moisture is completely removed from the molecular sieving carbon, some hydroxyl group and oxide may still remain on the surface of the adsorbent, and when SiF₄ is introduced, the hydroxyl group and the oxide on the surface of the activated carbon react to generate (SiF₃)₂O and HF.
SiF₄+(C—OH)+(C—H)→(SiF₃)₂O+2HF+(2C—F)

Accordingly, in a case where an adsorbent after baked is used, prior to the use, the adsorbent surface which may give impurities through reaction with SiF₄ may be allowed to contact and react with SiF₄, so that formation of the side products (SiF₃)₂O and HF may be reduced. Examples of method for contacting the adsorbent include a method of allowing the reaction to proceed while applying SiF₄ to the adsorbent and analyzing impurities at the reactor outlet (e.g., SiF₃OSiF₃) to confirm the end point, and a method of reacting the two under an accumulated pressure for a predetermined period of time. The contact reaction temperature is not limited as long as the temperature is sufficiently high for adsorption of impurities and the intended contact reaction may proceed without any difficulty, and after the reaction, the adsorbent may complete adsorption of impurities successfully. It is preferable that the reaction be performed under a pressure not higher than the pressure under which SiF₄ is liquefied. From the viewpoint of reducing the amount of SiF₄ to be used for the treatment, it is preferable that the reaction be performed under an atmospheric pressure or a pressure close to it. The purity of SiF₄ to be used is not specifically limited, however, SiF₄ containing a large quantity of impurities is disadvantageous in that the adsorbent may be broken through before the end of the pretreatment, and therefore, the higher the purity of SiF₄, the more preferable. SiF₄ that contains (SiF₃)₂O and HF formed in the pretreatment may be returned back to the reaction step 3 and may be purified.

In a case where SiF₄ contains low-boiling-point components such as N₂, O₂, H₂ and CO after removing impurities through adsorption by the molecular sieving carbon, the SiF₄ may be further purified through a conventional method such as distillation so as to further increase its purity.

Next, the use of the high-purity SiF₄ that is obtained according to the method of the present invention is described.

Increasing the transistor integration capacity along with downsizing in semiconductor devices brings about an advantage that a higher density in the device or a higher switching speed of each transistor in the devices can be achieved. However, the propagation delay owing to wiring may wipe out the advantage of transistor speed increment. The generation having a line width of 0.25 μm or more has a serious problem of wiring delay. In order to solve the problem, copper wiring of low resistance is being employed in place of aluminium, and low-dielectric interlayer insulating film is being employed for reducing interconnection capacity. One typical low-dielectric material employed in the generation having a line width of from 0.25 to 0.18 or 0.13 μm is SiOF (fluorine-doped oxide film, having ε of 3.5 or so) formed through HDP (high-density) plasma CVD. A process using SiOF as an interlayer insulating film and aluminium alloy as wiring is being employed. It is preferable that SiF₄ for producing such SiOF contain little amount of impurities such as transition metals, e.g., iron, nickel and copper as well as impurities such as phosphorus and boron that may worsen the properties of SiOF. Specifically, it is preferable that the content of transition metal, phosphorus and boron in SiF₄ is 100 ppb or less respectively, more preferably each 50 ppb or less, even more preferably each 10 ppb or less. High-purity SiF₄ of the present invention, satisfying the above requirements, can be used as the doping material for SiOF.

Glass for optical fibers comprises a core and a clad, in which the core part has a higher refractive index than that of the clad part present around it, so that light may be electrically transmitted smoothly through the center part. In order to increase the refractive index, the core may be doped with a dopant such as Ge, Al or Ti. However, addition of such adopant may involve a side effect of increasing light scattering in the core, resulting in decrease in the light transmission efficiency of the core. The light transmission efficiency may be increased by using a pure quartz or a quartz doped to a lower degree for the core part and adding fluorine to the clad to make the refractive index lower than that of pure quartz. For fluorine addition to the clad, glass particles (SiO₂) may be heated in an atmosphere of He/SiF₄. In the SiF₄ atmosphere, it is preferable that the amount of impurities such as transition metals, e.g., iron, nickel and copper as well as phosphorus and boron that may worsen the properties of optical fibers be as small as possible. Specifically, it is preferable that the content of transition metal, phosphorus and boron in SiF₄ is each 100 ppb or less, more preferably each 50 ppb or less, even more preferably each 10 ppb or less. The high-purity SiF₄ of the present invention, satisfying the above requirements, can be used for gas for optical fibers.

Silicon-based solar cells comprises pin-type photoelectromotive force devices. When its I-type semiconductor layer is formed of SiF₄, the silicon film may contain a small amount of F atoms. In that manner, by including fluorine atoms in the silicon thin film, when the surface of the photoelectromotive force devices receives light irradiation, interactions between heat and fluorine atoms promote the atomic rearrangement in and around the crystal grain boundaries in the devices, thereby alleviating the structural strain, and in addition, water assumed to penetrate mainly through the grain boundaries from the surfaces of the devices may react with fluorine and the resulting reaction product may bind to unbound valences of silicon atoms or may causes changes in the charge condition of the devices, whereby the optical conversion efficiency of the devices can be self-recovered. It is preferable that the production gas to be used under the condition contain little amount of impurities such as transition metals, e.g., iron, nickel and copper, as well as impurities such as phosphorus and boron that may worsen the properties of the devices. Specifically, it is preferable that the content of transition metal, phosphorus and boron in the production gas be each 100 ppb or less, more preferably each 50 ppb or less, even more preferably each 10 ppb or less. The high-purity SiF₄of the present invention, satisfying the above requirements, can be used for production of such solar cells.

### BRIEF DESCRIPTION OF THE DRAWINGS

FIG. 1 shows an outline of the reaction scheme of the invention.

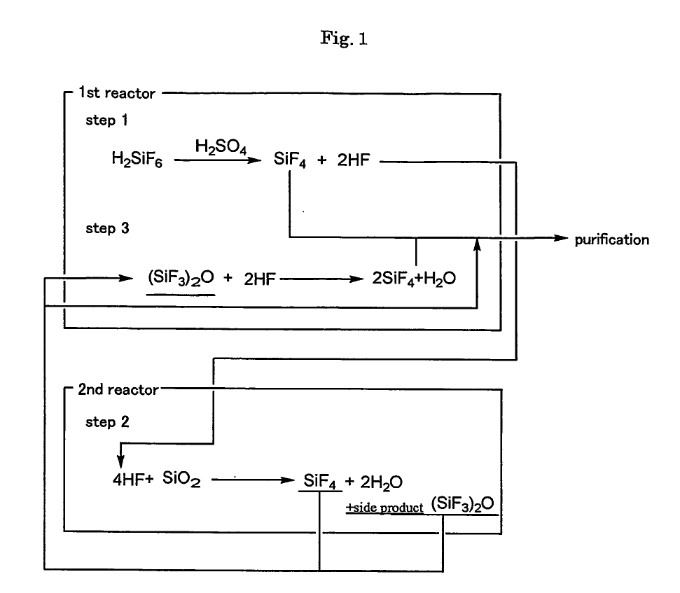

FIG. 2. shows an outline of the reaction system usable in the invention.

### BEST MODE FOR CARRYING OUT THE INVENTION

The present invention is specifically described with reference to the following Examples, however, the invention should not be limited thereto.

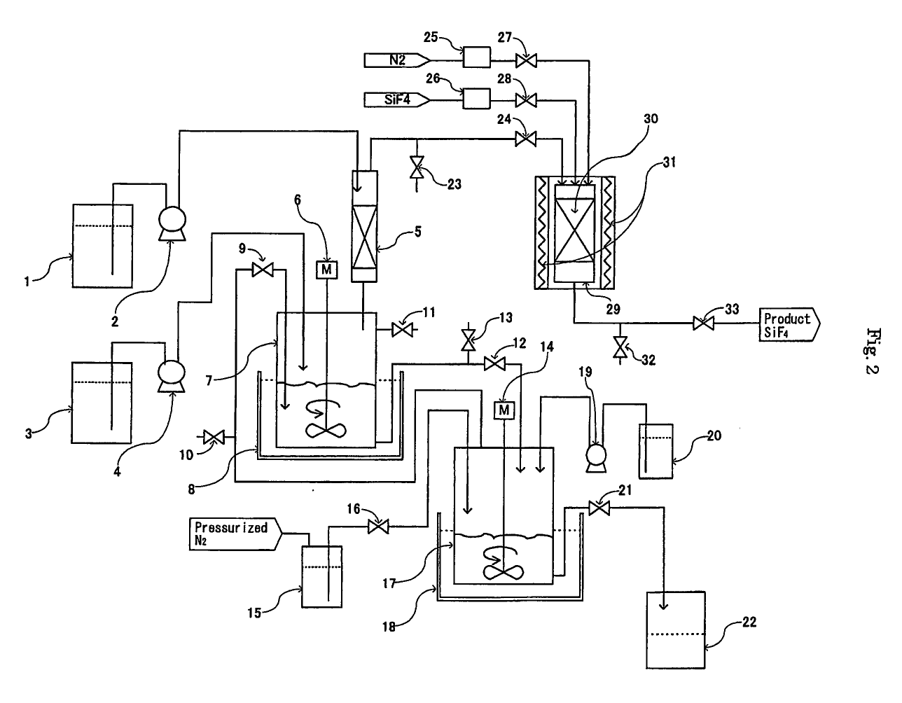

With reference to FIG. 2, the outline of the production system for use in the present invention is described.

In FIG. 2; 1 and 3 are a sulfuric acid tank and an H₂SiF₆ tank, respectively. Sulfuric acid and H₂SiF₆ are fed to the first reactor (7) via the metering pumps (2, 4), respectively. In continuous operation, sulfuric acid is fed into the system via the sulfuric acid washing column (5) where a product gas is washed, and the sulfuric acid also functions to purify the product gas. The first reactor (7) is kept at a predetermined temperature by using a heating means (8) such as oil bath. The solutions fed into the first reactor (7) are uniformly mixed by the stirrer motor (6).

In the first reactor, H₂SiF₆ is decomposed into SiF₄ and HF (step 1). Most of SiF₄ gas appears in the vapor phase, and this is taken out via the sulfuric acid washing column (5) into which sulfuric acid is continuously fed. The vapor phase in the first reactor (7) can be sampled out via the sampling valve (11) and analyzed; and the SiF₄ gas having passed through the sulfuric acid washing column (5) can be sampled out via the sampling valve (23) and analyzed.

SiO₂ dispersed in sulfuric acid is fed into the second reactor (17), from the tank (15) via the valve (16). On the other hand, at the time when the solution in the first reactor (7) has reached a predetermined level, the sulfuric acid solution (containing a large amount of side product, HF) in the first reactor (7) is fed to the second reactor (17) via the stop valve (12). The second reactor (17) is kept at a predetermined temperature using a heating means (18) such as oil bath. The solutions fed into the second reactor (17) are uniformly mixed by the stirrer motor (14).

In the second reactor (17), HF formed in step 1 is reacted with SiO₂ to give SiF₄ that contains an impurity, (SiF₃₎₂O, and H₂O (step 2). Most of the SiF₄ gas appears in the vapor phase, and can be sampled out via the sampling valve (10) and analyzed. When the stop valve (9) is opened, the SiF₄ gas can be introduced into the first reactor (7), to react the impurity (SiF₃₎₂O with the side product HF formed in step 1 to give SiF₄ (step 3). The sulfuric acid concentration in the second reactor (17) may be controlled by further adding sulfuric acid thereto from the sulfuric acid tank (20). Such a further supply of sulfuric acid can be made, for example, by using metering pump (19). The sulfuric acid may be taken out of the second reactor (17) and introduced into the waste sulfuric acid tank (22) via the valve (21). Accordingly, the liquid level in the system can be arbitrarily controlled.

The mixture of the SiF₄ gas which has been formed in step 1 in the first reactor and the SiF₄ gas which has been formed in step 2 in the second reactor and then purified in step 3 in the first reactor is introduced into the adsorbent (30) that has been previously baked, by opening the stop valve (24) after the reaction in each reactor has reached its steady condition, and the mixture is thereby purified through adsorption with the adsorbent (30) which has been subjected to baking treatment with heating means (31). Generally, baking is performed while introducing N₂ gas from a N₂ source via flow meter (25) and valve (27). Baking may be performed while introducing SiF₄ gas from a SiF₄ source via flow meter (26) and valve (28). The purified outlet gas from the adsorption cylinder (29) may also be sampled via the sampling valve (32) and analyzed. The thus purified gas is taken out of the system via stop valve (33).

Concrete data of the experiment carried out according to the operation mentioned above are shown below. In the following Examples, the dimension of the units that constitute the system is described, however, the present invention can be carried out using units at arbitrary scales, and the reactors and other units may comprise any materials so far as they are resistant to the reaction condition and do not interfere with the reaction.

### EXAMPLES 1 TO 8

500 ml of sulfuric acid solution having a concentration previously controlled was fed into the first reactor (7) (cylindrical reactor made of polytetrafluoroethylene, φ100×260 length, about 2 liters). The sulfuric acid solution was heated to the temperature as shown in Table 1, and aqueous 20% H₂SiF₆ solution and 98% H₂SO₄ were added thereto such that the concentration of the sulfuric acid solution in the reactor could be kept constant. The sulfuric acid was discharged through the valve (12) such that the amount of reaction solution in the reactor could be kept constant. After the reaction reached its steady condition, the product gas sampled out via the valve (11) was analyzed through FT-IR, and the sulfuric acid solution sampled out via the valve (13) was analyzed through ion chromatography. The results are shown in Table 1.

TABLE 1

| | Condition for Experiment | | | | | | | | |
|---|---|---|---|---|---|---|---|---|---|
| | Supply of | Supply of | Reaction | Impurity Concentration in SiF₄ | | | | Liquid Composition | |
| | 20% H₂SiF₆ | 98% H₂SO₄ | Temperature | HF | HCl | CO₂ | CO | H₂SO₄ | HF |
| Example | (g/min) | (g/min) | (° C.) | (vol. %) | (vol. %) | (vol. %) | (vol. %) | (mass %) | (mass %) |
| 1 | 4.0 | 24 | 80 | 3.5 | 2.8 | 0.05 | 0.09 | 85 | 0.8 |
| 2 | 4.0 | 24 | 100 | 5.8 | 2.9 | 0.15 | 0.07 | 85 | 0.8 |
| 3 | 4.0 | 24 | 120 | 10.8 | 2.8 | 0.17 | 0.06 | 85 | 0.7 |
| 4 | 4.0 | 16 | 80 | 2.8 | 2.6 | 0.04 | 0.11 | 80 | 1.1 |
| 5 | 4.0 | 16 | 100 | 5.6 | 2.7 | 0.09 | 0.09 | 80 | 1.1 |
| 6 | 4.0 | 10 | 80 | 2.2 | 2.8 | 0.05 | 0.03 | 73 | 1.6 |

### EXAMPLES 7 TO 10

The H₂SO₄ solution in Example 1 or 4 was constantly supplied into the second reactor (17) (φ100×260 length, about 2 liters) via the valve (12). A dispersion of SiO₂ in H₂SO₄ was fed into the reactor under an increased pressure with nitrogen, via the metering valve (16) at a constant flow rate relative to the amount of HF in the H₂SO₄ solution fed into the reactor. The temperature of the reaction solution was controlled by the oil bath, and sulfuric acid was constantly discharged out via the valve (21) so that the reaction solution level in the reactor could be kept constant. After the reaction reached its steady condition, the product gas was sampled out via the valve (10) and analyzed through FT-IR. The results are shown in Table 2.

TABLE 2

| | Condition for Experiment | | | | | | | |
|---|---|---|---|---|---|---|---|---|
| | | | SiO₂ dispersion in H₂SO₄ | | Reaction | Impurity Concentration in SiF₄ | | |
| | HF-containing | HF-containing | Supply | SiO₂ Concentration | Temperature | HF | CO₂ | (SiF₃)₂O |
| Example | H₂SO₄ used | H₂SO₄ (g/min) | (g/min) | (mass %) | (° C.) | (vol. %) | (vol. %) | (vol. %) |
| 7 | Example 4 | 17.5 | 1.8 | 4.0 | 80 | 0.5 | 0.001 | ND* |
| 8 | Example 4 | 17.5 | 2.88 | 4.0 | 80 | 0.02 | 0.002 | 0.1 |
| 9 | Example 4 | 17.5 | 3.5 | 4.0 | 80 | ND | 0.001 | 1.7 |
| 10 | Example 1 | 27.2 | 4 | 4.0 | 80 | ND | 0.001 | 1.9 |

*ND: not detected (less than detection limit)

### EXAMPLES 11, 12

The SiF₄ gas obtained in Example 9 was fed into the first reactor (7) via the valve (9), in which the reaction was continuing under the same condition as in Example 4. The product gas was sampled out via the valve (11), and analyzed through FT-IR. In addition, the product gas was led through the sulfuric acid washing column (5), and then sampled out via the valve (23) and analyzed through FT-IR. As sulfuric acid washing column (5), a 50 cm long ½-inch tube made of polytetrafluoroethylene, which was filled with a filler of polytetrafluoroethylene (120 ml), was used. The results are shown in Table 3.

TABLE 3

| | Impurity Concentration in SiF₄ | | | | | | Amount of SiF₄ |
|---|---|---|---|---|---|---|---|
| | Sample | HF | HCl | CO₂ | CO | (SiF₃)₂O | formed |
| | Valve | (vol. %) | (vol. %) | (vol. %) | (vol. %) | (vol. %) | (Nml/min) |
| Example 11 | 11 | 1.9 | 1.7 | 0.11 | 0.04 | ND* | 184 |
| Example 12 | 23 | 0.01 | 1.8 | 0.11 | 0.04 | ND* | 184 |

*ND: not detected (less than detection limit)

### EXAMPLES 13, 14

The gas in Example 12 was introduced into the adsorption cylinder (29). The adsorption properties were compared between a case using an adsorbent baked with N₂ alone and a case using an adsorbent baked with N₂ and further pretreated with SiF₄.

As the adsorption cylinder, a ¾-inch SUS tube was used, and was filled with 100 ml of an adsorbent, Molsiebon 4A (manufactured by Takeda Pharmaceutical Co., Ltd.). The adsorbent was baked at 300° C. with N₂ applied thereto at a rate of 400 ml/min, and the baking was continued until the outlet dew point reached −70° C. or lower. After this was cooled to room temperature, and the same gas as that in Example 12 was introduced thereinto, and the outlet gas was analyzed.

In the other case, where the baked adsorbent was further treated with high-purity SiF₄, SiF₄ was introduced to the adsorbent at room temperature at a flow rate of 100 ml/min, and the outlet gas was intermittently analyzed through FT-IR. The pretreatment was continued until no hexafluorodisiloxane was detected in the outlet gas. After completion of the pretreatment, the same gas as that in Example 12 was introduced thereto, and the outlet gas was analyzed. The results are shown in Table 4 and Table 5.

TABLE 4
Example 13 (not pretreated with SiF₄)

Impurity Concentration in SiF₄

| Time | HF | HCl | CO₂ | (SiF₃)₂O |
|---|---|---|---|---|
| (min) | (vol. %) | (vol. %) | (vol. %) | (vol. %) |
| 10 | 0.05 | ND* | ND* | 0.13 |
| 30 | 0.04 | ND* | ND* | 0.1 |
| 60 | 0.01 | ND* | ND* | 0.05 |

*ND: not detected (less than detection limit)

TABLE 5
Example 14 (pretreated with SiF₄)

Impurity Concentration in SiF₄

| Time | HF | HCl | CO₂ | (SiF₃)₂O |
|---|---|---|---|---|
| (min) | (vol. %) | (vol. %) | (vol. %) | (vol. %) |
| 10 | ND | ND | ND | ND |
| 30 | ND | ND | ND | ND |
| 60 | ND | ND | ND | ND |

ND: not detected (less than detection limit)
As seen in the above results, SiF₄ gas containing impurities in an amount undetectable through FT-IR could be continuously produced.

### INDUSTRIAL APPLICABILITY

As described above, the present invention enables continuous production of SiF₄ gas containing impurities at a concentration reduced to a level as low as undetectable through FT-IR. Accordingly, the present invention enables production of high-purity SiF₄ that has been demanded in the electronic component industry. Moreover, according to the present invention, HF that is discarded as a side product in conventional methods can be utilized in producing SiF₄, and the utilization efficiency of starting materials is high, and discharge of harmful substances can be reduced.

1. A method for producing tetrafluorosilane by decomposing hexafluorosilicic acid with sulfuric acid, which comprises:
a step of decomposing hexafluorosilicic acid in concentrated sulfuric acid in a first reactor to give tetrafluorosilane and hydrogen fluoride, and taking out the thus-formed tetrafluorosilane (step 1);
a step of transferring at least a part of the concentrated sulfuric acid solution of step 1 containing hydrogen fluoride into a second reactor to allow the hydrogen fluoride to react with silicon dioxide which is fed into the second reactor, thereby producing tetrafluorosilane containing hexafluorodisiloxane (step 2); and
a step of bringing the reaction product of step 2 containing hexafluorodisiloxane and tetrafluorosilane to the first reactor so that the hexafluorodisiloxane in the reaction product is reacted with hydrogen fluoride to convert it into tetrafluorosilane, and taking out the resulting tetrafluorosilane along with the tetrafluorosilane formed in step 1 (step 3).

2. The method for producing tetrafluorosilane as claimed in claim 1, wherein an aqueous hexafluorosilicic acid solution and concentrated sulfuric acid are fed into the first reactor, silicon dioxide is fed into the second reactor each continuously or intermittently, and tetrafluorosilane is continuously or intermittently taken out of the first reactor.

3. The method for producing tetrafluorosilane as claimed in claim 1, wherein the sulfuric acid concentrations in the first and second reactors are kept 70 mass % or more.

4. The method for producing tetrafluorosilane as claimed in claim 1, wherein the reaction temperatures in the first and second reactors are 60° C. or higher.

5. The method for producing tetrafluorosilane as claimed in claim 1, wherein the particle size of silicon dioxide fed to the second reactor is 30 μm or less.

6. The method for producing tetrafluorosilane as claimed in claim 1, comprising a step of contacting the tetrafluorosilane taken out of the first reactor with concentrated sulfuric acid at 50° C. or lower so that hydrogen fluoride contained in the tetrafluorosilane is absorbed and removed.

7. The method for producing tetrafluorosilane as claimed in claim 6, wherein the tetrafluorosilane taken out of the first reactor is countercurrently contacted with concentrated sulfuric acid that is supplied through a channel to the first reactor.

8. The method for producing tetrafluorosilane as claimed in claim 1, comprising a step of purifying the tetrafluorosilane taken out of the first reactor with molecular sieving carbon so as to remove the impurities from the tetrafluorosilane.

9. The method for producing tetrafluorosilane as claimed in claim 8, wherein the removed impurities include one or more members selected from the group consisting of hydrogen fluoride, hydrogen chloride, sulfur dioxide, hydrogen sulfide and carbon dioxide.

10. The method for producing tetrafluorosilane as claimed in claim 8, wherein the molecular sieving carbon to be used has a smaller pore size than the molecular size of tetrafluorosilane.

11. The method for producing tetrafluorosilane as claimed in claim 10, wherein the molecular sieving carbon pretreated by baking in an inert gas atmosphere and then introducing thereinto high-purity tetrafluorosilane is used.

12. Gas for production of optical fibers, which contains the tetrafluorosilane gas obtained according to the production method as described in claim 1, comprising transition metal, phosphorus and boron each at concentration of 100 ppb or less.

13. Gas for production of semiconductors, which contains the tetrafluorosilane gas obtained according to the production method as described in claim 1, comprising transition metal, phosphorus and boron each at concentration of 100 ppb or less.

14. Gas for production of solar cells, which contains the tetrafluorosilane gas obtained according to the production method as described in claim 1, comprising transition metal, phosphorus and boron each at concentration of 100 ppb or less.
